(19) United States
(12) Patent Application Publication
(10) Pub. No.: US 2013/0052564 A1
(43) Pub. Date: Feb. 28, 2013

(54) POLYMER ELECTROLYTE MEMBRANE, MEMBRANE-ELECTRODE ASSEMBLY, AND SOLID POLYMER FUEL CELL

(71) Applicants: Taiga Sakai, Tsukuba-shi (JP); Yoichiro Machida, Tokyo (JP); Shin Saito, Tsukuba-shi (JP)

(72) Inventors: Taiga Sakai, Tsukuba-shi (JP); Yoichiro Machida, Tokyo (JP); Shin Saito, Tsukuba-shi (JP)

(73) Assignee: SUMITOMO CHEMICAL COMPANY, LIMITED, Chuo-ku, Tokyo (JP)

(21) Appl. No.: 13/501,366

(22) PCT Filed: Oct. 15, 2010
(86) PCT No.: PCT/JP2010/068650

§ 371 Date: May 11, 2012

(30) Foreign Application Priority Data
Oct. 16, 2009 (JP) 2009-239087

(51) Int. Cl. H01M 8/10; C08J 5/22

(52) U.S. Cl. 429/493; 521/27

(57) ABSTRACT

A polymer electrolyte membrane which exhibits superior high-temperature operability and a fuel cell and the like comprising the polymer electrolyte membrane are provided. In an aspect, the present invention relates to a polymer electrolyte membrane comprising a polymer electrolyte and having a first surface and a second surface, wherein the water vapor permeability coefficient from the first surface of the polymer electrolyte membrane to the second surface which is measured in a state where the first surface is exposed to a humidified environment of a temperature of 85° C. and a relative humidity of 20% and the second surface is exposed to a non-humidified environment of a temperature of 85° C. and a relative humidity of 0% is equal to or higher than 7.0×10⁻¹⁰ mol/sec/cm, and the breaking stress at a temperature of 80° C. and a relative humidity of 90% is equal to or greater than 20 MPa.

### TECHNICAL FIELD

The present invention relates to a polymer electrolyte membrane, a membrane-electrode assembly having the polymer electrolyte membrane, and a solid polymer fuel cell.

### BACKGROUND ART

Polymer electrolyte membranes including a polymer (polymer electrolyte) having ion conductivity have been used as barrier membranes of primary cells, secondary cells, solid polymer fuel cells (hereinafter sometimes referred to as a “fuel cell”), or the like. For example, fluorine-based polymer electrolytes such as Nafion (a registered trademark of Du Pont de Nemours & Co.) are mainly being considered.

A fuel cell has as a basic configuration a cell (a fuel cell) in which an electrode called a catalyst layer including a catalyst promoting the oxidation-reduction reaction of hydrogen and oxygen is formed on both surfaces of the polymer electrolyte membrane and a gas diffusion layer efficiently supplying gas to the catalyst layers is formed on the catalyst layers. Here, the structure in which the catalyst layers are formed on both surfaces of the polymer electrolyte membrane is generally referred to as a membrane-electrode assembly (hereinafter sometimes referred to as an “MEA”).

Recently, the fuel cells have required operability at relatively high temperatures (hereinafter sometimes referred to as “high-temperature operability”). Practical application of the fuel cells is mainly anticipated in vehicles and in stationary machines, and high-temperature operability is required for simplifying accessories such as humidifiers and radiators for use in vehicles and for preventing poisoning of the catalyst due to carbon monoxide included in modified hydrogen gas when modified hydrogen gas is used in stationary machines. However, there are problems associated with the fluorine-based polymer electrolytes such as the above-mentioned Nafion in that they exhibit inferior heat resistance, are low in mechanical strength at high temperatures, and are not practical without some kind of reinforcement. In response to this requirement for such high-temperature operability, improvement of the polymer electrolyte membrane in the MEA has been tried.

For example, JP-2007-207625-A discloses a solid polymer electrolyte in which a specific organic metal compound and an organic polymer having proton conductivity are combined, in which the solid polymer electrolyte is superior in water retentivity and exhibits relatively outstanding high-temperature operability.

Nevertheless, the polymer electrolyte membranes obtained hitherto are inadequate in terms of high-temperature operability.

### DISCLOSURE OF INVENTION

An object of the present invention is to provide a polymer electrolyte membrane which is superior in high-temperature operability to conventional polymer electrolyte membranes and a fuel cell and the like using the polymer electrolyte membrane.

The present inventors have variously studied the improvement of high-temperature operability and have found that it is possible to improve the high-temperature operability by setting the water vapor permeability coefficient of the polymer electrolyte membrane to a specific range rather than by the improvement of water retentivity of the polymer electrolyte membrane disclosed in JP-2007-207625-A.

That is, the present invention provides the following <1> to <12>.

<1> A polymer electrolyte membrane comprising a polymer electrolyte and having a first surface and a second surface, wherein the water vapor permeability coefficient from the first surface of the polymer electrolyte membrane to the second surface which is measured in a state where the first surface is exposed to a humidified environment of a temperature of 85° C. and a relative humidity of 20% and the second surface is exposed to a non-humidified environment of a temperature of 85° C. and a relative humidity of 0% is equal to or higher than 7.0×10⁻¹⁰ mol/sec/cm, and the breaking stress which is measured in a state where the polymer electrolyte membrane is exposed to a humidified environment of a temperature of 80° C. and a relative humidity of 90% is equal to or greater than 20 MPa;

<2> A polymer electrolyte membrane comprising a polymer electrolyte and having a first surface and a second surface, wherein the water vapor permeability coefficient from the first surface of the polymer electrolyte membrane to the second surface which is measured in a state where the first surface is exposed to a humidified environment of a temperature of 85° C. and a relative humidity of 20% and the second surface is exposed to a non-humidified environment of a temperature of 85° C. and a relative humidity of 0% is equal to or higher than 7.0×10⁻¹⁰ mol/sec/cm, and the oxygen permeability coefficient from the first surface to the second surface is equal to or less than 1.0×10⁻⁹ cc·cm/cm²·sec·cmHg;

<3> The polymer electrolyte membrane according to <1> or <2>, wherein the ion exchange capacity of the polymer electrolyte is 3.0 meq/g;

<4> The polymer electrolyte membrane according to <3>, wherein the thickness of the polymer electrolyte membrane is in the range of not less than 10 μm and not more than 40 μm.

<5> The polymer electrolyte membrane according to <1> or <2>, wherein the thickness of the polymer electrolyte membrane is in the range of not less than 3 μm and not more than 12 μm;

<6> The polymer electrolyte membrane according to <5>, wherein the ion exchange capacity of the polymer electrolyte is in the range of not less than 2.0 meq/g and not more than 3.0 meq/g;

<7> A polymer electrolyte membrane comprising a polymer electrolyte and having a first surface and a second surface, wherein the water vapor permeability from the first surface of the polymer electrolyte membrane to the second surface which is measured in a state where the first surface is exposed to a humidified environment of a temperature of 85° C. and a relative humidity of 20% and the second surface is exposed to a non-humidified environment of a temperature of 85° C. and a relative humidity of 0% is equal to or higher than 1.0×10⁻⁶ mol/sec/cm², and the oxygen permeability from the first surface to the second surface is equal to or less than 5.0×10⁴ cc/m²·24 h·atm;

<8> The polymer electrolyte membrane according to any one of <1> to <7>, wherein the polymer electrolyte is a hydrocarbon-based polymer electrolyte;

<9> The polymer electrolyte membrane according to any one of <1> to <8>, wherein the polymer electrolyte is an aromatic polymer electrolyte;

<10> The polymer electrolyte membrane according to any one of <1> to <9>, wherein the polymer electrolyte includes a segment having an ion-exchange group and a segment having substantially no ion-exchange groups and the segment having an ion-exchange group has a structure represented by formulas (1a), (2a), (3a), or (4a) below:

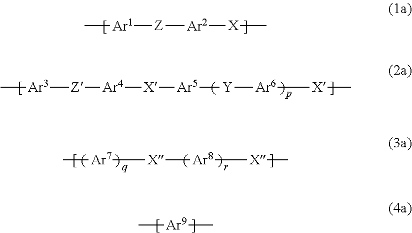

wherein Ar¹ to Ar⁹ each independently represents an aromatic group which has an aromatic ring in a main chain and which may have a side chain having an aromatic ring, at least one of the aromatic ring in the main chain and the aromatic ring in the side chain has an ion-exchange group directly bonded to the aromatic ring, Z and Z′ each independently represents either CO or SO₂, X, X′ and X″ each independently represents either O or S, Y represents a direct bond or a group represented by formula (10) below, p represents 0, 1 or 2, and q and r each independently represents 1, 2 or 3,

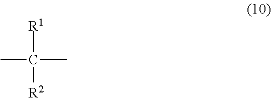

wherein R¹ and R² each independently represents a hydrogen atom, an alkyl group with a carbon number of 1 to 20 which may have a substituent group, an alkoxy group with a carbon number of 1 to 20 which may have a substituent group, an aryl group with a carbon number of 6 to 20 which may have a substituent group, an aryloxy group with a carbon number of 6 to 20 which may have a substituent group, or an acyl group with a carbon number of 2 to 20 which may have a substituent group, and R¹ and R² may be linked to form a ring;

<11> The polymer electrolyte membrane according to any one of <1> to <10>, wherein Ar¹ to Ar⁹ each have at least one ion-exchange group in the aromatic group constituting the main chain; and

<12> The polymer electrolyte membrane according to any one of <1> to <11>, wherein the polymer electrolyte is a copolymer electrolyte which includes a segment having an ion-exchange group and a segment having substantially no ion-exchange groups and the copolymerization pattern of which is block copolymerization or graft copolymerization, the polymer electrolyte membrane has a microphase-separated structure comprising a phase in which the density of the segment having an ion-exchange group is higher than the density of the segment having substantially no ion-exchange groups and a phase in which the density of the segment having substantially no ion-exchange groups is higher than the density of the segment having an ion-exchange group.

The present invention also provides the following <9> using any one of the above-mentioned polymer electrolyte membrane.

<13> A membrane-electrode assembly comprising the polymer electrolyte membrane according to any one of <1> to <12>.

<14> A solid polymer fuel cell comprising the membrane-electrode assembly according to <13>.

### BRIEF DESCRIPTION OF DRAWINGS

FIG. 1 is a cross-sectional view illustrating a fuel cell according to an embodiment of the present invention. In the drawing, reference 10 represents a fuel cell, reference 12 represents a polymer electrolyte membrane, reference 14a represents an anode catalyst layer, reference 14b represents a cathode catalyst layer, references 16a and 16b represent gas diffusion layers, respectively, references 18a and 18b represent separators, respectively, and reference 20 represents a membrane-electrode assembly (MEA).

### EMBODIMENT FOR CARRYING OUT THE INVENTION

Hereinafter, a preferred embodiment of the present invention will be described with reference to the accompanying drawing if necessary.

A first aspect of the present invention provides a polymer electrolyte membrane comprising a polymer electrolyte and having a first surface and a second surface, wherein the water vapor permeability coefficient from the first surface of the polymer electrolyte membrane to the second surface which is measured in a state where the first surface is exposed to a humidified environment of a temperature of 85° C. and a relative humidity of 20% and the second surface is exposed to a non-humidified environment of a temperature of 85° C. and a relative humidity of 0% is equal to or higher than 7.0×10⁻¹⁰ mol/sec/cm, and the breaking stress which is measured in a state where the polymer electrolyte membrane is exposed to a humidified environment of a temperature of 80° C. and a relative humidity of 90% is equal to or greater than 20 MPa. Hereinafter, with respect to the polymer electrolyte membrane, a suitable polymer electrolyte included in the polymer electrolyte membrane, a method of producing the polymer electrolyte membrane, and a membrane-electrode assembly and a fuel cell using the polymer electrolyte membrane will be sequentially described.

### <Polymer Electrolyte>

The polymer electrolyte constituting the polymer electrolyte membrane according to the present invention is a polymer electrolyte having an ion-exchange group. Although both a polymer electrolyte having an acidic group and a polymer electrolyte having a basic group can be employed, the polymer electrolyte having an acidic group can be preferably used since a fuel cell superior in electric power generation performance can be obtained. Examples of the acidic group include a sulfo group (—SO₃H), a carboxyl group (—COOH), a phospho group (—PO₃H₂), a sulfanilamide group (—SO₂NHSO₂—), and a phenolic hydroxyl group. Among these, the polymer electrolyte used in the present invention preferably has a sulfo group and/or a phospho group and more preferably have a sulfo group.

To enhance the effect of the present invention, an ion exchange capacity (hereinafter, referred to as “IEC”) indicating the amount of acidic group introduced into the polymer electrolyte is preferably 3.0 meq/g or more and more preferably 3.5 meq/g or more, and still more preferably 4.0 meq/g or more. The upper limit of the IEC is preferably 7.0 meq/g or less, more preferably 6.5 meq/g or less, and still more preferably 6.0 meq/g or less. When the IEC is 3.0 meq/g or more, the water vapor permeability coefficient is apt to increase and can be easily set to the above-mentioned range. On the other hand, when the polymer electrolyte equal to or less than 7.0 meq/g is used, the water retentivity of the resultant polymer electrolyte membrane is not damaged and the durability of the polymer electrolyte membrane tends to increase during the operation of the fuel cell. When the polymer electrolyte membrane within the IEC range is used, the thickness of the electrolyte membrane is preferably in the range of 10 μm to 40 μm and more preferably in the range of 20 μm to 30 μm.

To further enhance the effect of the present invention, the decrease in thickness of the polymer electrolyte membrane is also effective. The thickness of the polymer electrolyte membrane in the present invention is preferably 12 μm or less, more preferably 9 μm or less, and still more preferably 7 μm or less. On the other hand, in that it is possible to obtain practically satisfactory strength as a polymer electrolyte membrane used in a fuel cell, the thickness is preferably 3 μm or more and more preferably more than 5 μm. When the thickness becomes smaller, the water vapor permeability coefficient tends to become larger, but the oxygen permeability coefficient also becomes larger and the mechanical strength of the membrane during absorbing moisture tends to become smaller. Therefore, it is necessary to select the optimal thickness in consideration of the types of the polymer electrolyte included in the polymer electrolyte membrane to be used. The suitable IEC of the electrolyte membrane when the polymer electrolyte membrane within the thickness range is used is preferably in the range of 2.0 meq/g to 3.0 meq/g and more preferably in the range of 2.5 meq/g to 3.0 meq/g.

Representative examples of the polymer electrolyte include:

(A) a polymer electrolyte comprising a polymer (that is, a hydrocarbon-based polymer) of which the main chain is aliphatic hydrocarbon and into which a sulfo group and/or a phospho group is introduced;

(B) a polymer electrolyte comprising a polymer (that is, fluorine-based polymer) in which all or a part of hydrogen atoms of aliphatic hydrocarbon are substituted with a fluorine atom and into which a sulfo group and/or a phospho group is introduced;

(C) a polymer electrolyte comprising a polymer (that is, aromatic polymer) of which the main chain has an aromatic ring and into which a sulfo group and/or a phospho group is introduced;

(D) a polymer electrolyte comprising a polymer (inorganic polymer) of which the main chain has an inorganic unit structure such as a siloxane group and a phosphazene group and into which a sulfo group and/or a phospho group is introduced;

(E) a polymer electrolyte comprising a copolymer having two or more species of repeating units selected from the repeating units described in (A) to (D) and into which a sulfo group and/or a phospho group is introduced; and

(F) a polymer electrolyte comprising a hydrocarbon-based polymer of which the main chain or the side chain has a nitrogen atom and into which an acidic compound such as a sulfuric acid and a phosphoric acid is introduced by ionic bonding.

Examples of the polymer electrolyte (A) include polyvinyl sulfonate, polystyrene sulfonate, and poly(α-methylstyrene) sulfonate.

Examples of the polymer electrolyte (B) include Nafion (registered trademark) made by Du Pont de Nemours & Co., Aciplex (registered trademark) made by Asahi Kasei Corporation, and Flemion (registered trademark) made by Asahi Glass Co., Ltd. Other examples include a sulfonated polystyrene-graft-ethylene-tetrafluoroethylene copolymer (ETFE) having a main chain formed by copolymerization of a fluorocarbon-based vinyl monomer and a hydrocarbon-based vinyl monomer and a hydrocarbon side chain including a sulfo group, which is described in JP-H9-102322-A, and a sulfonated poly(trifluorostyrene)-graft-ETFE which is a solid polymer electrolyte obtained by graft-polymerizing a membrane formed by copolymerization of a fluorocarbon-based vinyl monomer and a hydrocarbon-based vinyl monomer with α,β,β-trifluorostyrene and introducing a sulfo group into the graft polymer, which is described in U.S. Pat. No. 4,012,303 and U.S. Pat. No. 4,605,685.

Examples of the polymer electrolyte (C) include polymer electrolytes in which the main chain is linked with a hetero atom such as an oxygen atom, polymer electrolytes in which a sulfo group is introduced into each of homopolymers such as polyether ether ketone, polysulfone, polyethersulfone, poly(arylene ether), polyimide, poly((4-phenoxybenzoyl)-1,4-phenylene), polyphenylenesulfide, and polyphenylquinoxaline, sulfoarylated polybenzimidazole, sulfoakylated polybenzimidazole, phosphoalkylated polybenzimidazole (for example, see JP-H9-110982-A), and phosphonated poly(phenylene ether) (for example, see J. Appl. Polym. Sci., 18, 1969 (1974)).

Examples of the polymer electrolyte (D) include polymer electrolytes in which a sulfo group is introduced into polyphosphazene described in Polymer Prep., 41, No. 1, 70 (2000). The examples further include polysiloxane having a phospho group which can be easily produced.

Examples of the polymer electrolyte (E) include polymer electrolytes in which a sulfo group and/or a phospho group is introduced into a random copolymer, polymer electrolytes in which a sulfo group and/or a phospho group is introduced into an alternate copolymer, polymer electrolytes in which a sulfo group and/or a phospho group is introduced into a graft copolymer, and polymer electrolytes in which a sulfo group and/or a phospho group is introduced into a block copolymer. An example of the polymer electrolyte in which a sulfo group is introduced into a random copolymer is a sulfonated polyethersulfone copolymer described in JP-H11-116679-A.

Examples of the polymer electrolyte (F) include a polybenzimidazole containing a phosphoric acid group which is described in JP-H11-503262-T.

Among the above-mentioned polymer electrolytes, the hydrocarbon-based polymer electrolytes can be preferably used in view of a recycling property or a low cost. The “hydrocarbon-based polymer electrolyte” means a polymer electrolyte in which the content of a halogen atom (such as a fluorine atom) is 15 wt % or lessin terms of the element weight composition ratio of the polymer electrolyte. Particularly, in the polymer electrolyte (E), hydrocarbon-based polymers comprising a repeating unit having an ion-exchange group and a repeating unit having no ion-exchange groups can be preferably used, since it is possible to easily obtain a polymer electrolyte membrane having practically satisfactory characteristics such as mechanical strength and water resistance.

Among the hydrocarbon-based polymer electrolytes, the aromatic polymer electrolytes can be preferably used. An aromatic polymer electrolyte means a polymer compound having an aromatic ring in a main chain of a polymer chain and having an ion-exchange group directly bonded to all or a part of the aromatic ring and/or an ion-exchange group bonded thereto via an appropriate linking group. The aromatic polymer electrolytes soluble in a solvent are usually used. When such aromatic polymer electrolytes are used, it is possible to easily obtain a polymer electrolyte membrane by a solution casting method to be described later. The polymer electrolyte membrane obtained by the solution casting method using the aromatic polymer electrolytes may be a nonporous polymer electrolyte membrane having a satisfactorily low oxygen permeability coefficient and a mechanical strength superior at a high temperature as described later. To obtain a polymer electrolyte membrane superior in heat resistance, an aromatic polymer electrolyte having a repeating unit having an aromatic ring among the polymer electrolytes (E) can be preferably used. Such aromatic polymer electrolytes can be used particularly preferably as the polymer electrolyte in the present invention since they can enhance a water vapor permeability coefficient to be described later and can easily lower the oxygen permeability coefficient.

The “polymer having an aromatic ring in a main chain” means a polymer of which the main chain has aromatic groups linked each other like polyarylene or a polymer in which aromatic groups are linked via a bivalent group to form the main chain. Examples of the bivalent group include an oxy group, a thioxy group, a carbonyl group, a sulfinyl group, a sulfonyl group, an amide group, an ester group, an ester carbonate group, an alkylene group with a carbon number of 1 to 4, a fluorine-substituted alkylene group with a carbon number of 1 to 4, an alkenylene group with a carbon number of 2 to 4, and an alkynylene group with a carbon number of 2 to 4. Examples of the aromatic group include aromatic groups such as a phenylene group, a naphthalene group, an anthracenyl group, and a fluorenediyl group and aromatic heterocyclic groups such as a pyridinediyl group, a furandiyl group, a thiophenediyl group, an imidazolyl group, an indolediyl group, and a quinoxalinediyl group.

The aromatic groups may have a substituent group in addition to the ion-exchange group. Examples of the substituent group include an alkyl group with a carbon number of 1 to 20, an alkoxy group with a carbon number of 1 to 20, an aryl group with a carbon number of 6 to 20, an aryloxy group with a carbon number of 6 to 20, a nitro group, and a halogen atom. When a halogen atom is included as the substituent group or when the fluorine-substituted alkylene group is included as the bivalent group used to link the aromatic groups, the content of the halogen atom is 15 wt % or less in terms of the element weight composition ratio of the aromatic polymer electrolyte.

The hydrocarbon-based polymer electrolyte as the suitable polymer electrolyte (E) will be described below in detail. Among such hydrocarbon-based polymer electrolytes, copolymer electrolytes having a segment having an ion-exchange group and a segment having substantially no ion-exchange groups can be preferably used since the polymer electrolyte membrane formed thereof tends to be superior in water resistance or mechanical strength. The copolymerization pattern of the two types of segments may be any one of random copolymerization, alternate copolymerization, block copolymerization, and graft copolymerization and may be a combination of the copolymerization patterns. However, a hydrocarbon-based polymer electrolyte of which the copolymerization pattern is block copolymerization or graft copolymerization is preferable. The “segment having an ion-exchange group” means a segment which contains an average of at least 0.5 ion-exchange groups per repeating unit constituting the segment, and which preferably contains an average of at least 1.0 ion-exchange groups per repeating unit. The “segment having substantially no ion-exchange groups” means a segment which contains an average of not more than 0.1 ion-exchange groups per repeating unit constituting the segment, and which preferably contains an average of not more than 0.05 ion-exchange-groups per repeating unit, and it is more preferable that the segment does not have any ion-exchange group.

Preferable examples of the polymer electrolyte include polymer electrolytes having a segment having an ion-exchange group, which is represented by formulas (1a), (2a), (3a), or (4a) below (hereinafter sometimes referred to as “any one of formulas (1a) to (4a)”), and a segment having substantially no ion-exchange groups, which is represented by formulas (1b), (2b), (3b), or (4b) below (hereinafter sometimes referred to as “any one of formulas (1b) to (4b)”), and having a copolymerization pattern of block copolymerization or graft copolymerization:

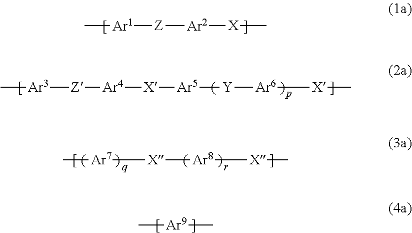

wherein Ar¹ to Ar⁹ each independently represents an aromatic group which has an aromatic ring in a main chain and which may have a side chain having an aromatic ring, at least one of the aromatic ring in the main chain and the aromatic ring in the side chain has an ion-exchange group directly bonded to the aromatic ring, Z and Z′ each independently represents either CO or SO₂, X, X′ and X″ each independently represents either O or S, Y represents a direct bond or a group represented by formula (10) below, p represents 0, 1 or 2, and q and r each independently represents 1, 2 or 3,

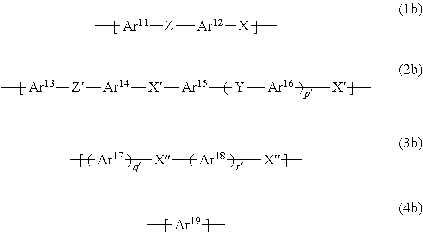

wherein Ar¹¹ to Ar¹⁹ each independently represents an aromatic carbon group which may have a substituent as a side chain, Z and Z′ each independently represents either CO or SO₂, X, X′ and X″ each independently represents either O or S, Y represents a direct bond or a group represented by formula (10) below, p′ represents 0 1, or 2, and q′ and r′ each independently represents 1, 2 or 3,

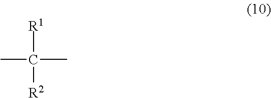

wherein R¹ and R² each represents a hydrogen atom, an alkyl group with a carbon number of 1 to 20 which may have a substituent group, an alkoxy group with a carbon number of 1 to 20 which may have a substituent group, an aryl group with a carbon number of 6 to 20 which may have a substituent group, an aryloxy group with a carbon number of 6 to 20 which may have a substituent group, or an acyl group with a carbon number of 2 to 20 which may have a substituent group, and R¹ and R² may be linked to form a ring.

Ar¹ to Ar⁹ in the formulas (1a) to (4a) each represents an aromatic group. Examples of the aromatic group include monocyclic aromatic groups such as 1,3-phenylene and 1,4-phenylene, condensed-ring aromatic groups such as 1,3-naphthalenediyl, 1,4-naphthalenediyl, 1,5-naphthalenediyl, 1,6-naphthalenediyl, 1,7-naphthalenediyl, 2,6-naphthalenediyl, and 2,7-naphthalenediyl, and heteroaromatic groups such as pyridinediyl, quinoxalinediyl, and thiophenediyl. Among these, the monocyclic aromatic groups are preferable.

Each Ar¹ to Ar⁹ may be substituted with an alkyl group with a carbon number of 1 to 20 which may have a substituent group, an alkoxy group with a carbon number of 1 to 20 which may have a substituent group, an aryl group with a carbon number of 6 to 20 which may have a substituent group, an aryloxy group with a carbon number of 6 to 20 which may have a substituent group, or an acyl group with a carbon number of 2 to 20 which may have a substituent group.

Each Ar¹ to Ar⁹ may have at least one ion-exchange group in an aromatic ring constituting the main chain. The above-mentioned acidic groups are preferable as the ion-exchange group and the sulfo group among the acidic groups is more preferable.

The degree of polymerization of the segment having the structural unit selected from the formulas (1a) to 4(a) is 5 or more, preferably in the range of 5 to 1000, and more preferably in the range of 10 to 500. When the degree of polymerization is 5 or more, proton conductivity is exhibited which is sufficient for the polymer electrolyte for a fuel cell. When the degree of polymerization is 1000 or less, the copolymer having the structural unit selected from the formulas (1a) to (4a) can be easily produced.

On the other hand, each Ar¹¹ to Ar¹⁹ in the formulas (1b) to (4b) represents an aromatic group. Examples of the aromatic group include bivalent monocyclic aromatic groups such as 1,3-phenylene and 1,4-phenylene, condensed-ring aromatic groups such as 1,3-naphthalenediyl, 1,4-naphthalenediyl, 1,5-naphthalenediyl, 1,6-naphthalenediyl, 1,7-naphthalenediyl, 2,6-naphthalenediyl, and 2,7-naphthalenediyl, and heteroaromatic groups such as pyridinediyl, quinoxalinediyl, and thiophenediyl. Among these, the monocyclic aromatic groups are preferable.

Each Ar¹¹ to Ar¹⁸ may be substituted with an alkyl group with a carbon number of 1 to 20 which may have a substituent group, an alkoxy group with a carbon number of 1 to 20 which may have an substituent group, an aryl group with a carbon number of 6 to 20 which may have a substituent group, an aryloxy group with a carbon number of 6 to 20 which may have a substituent group, or an acyl group with a carbon number of 2 to 20 which may have a substituent group. Here, the substituent group in the expression “may have a substituent group” does not include an ion-exchange group.

Here, examples of the substituent group which may be included in the above-mentioned aromatic groups (Ar¹ to Ar⁹ and Ar¹¹ to Ar¹⁹) include alkyl groups such as a methyl group, an ethyl group, and a butyl group, alkoxy groups such as a methoxy group, an ethoxy group, and a butoxy group, aryl groups such as a phenyl group, aryloxy groups such as a phenoxy group, and acyl groups such as an acetyl group and a butyryl group.

The degree of polymerization of the segment having the structural unit selected from the formulas (1b) to (4b) is 5 or more, preferably in the range of 5 to 100, and more preferably in the range of 5 to 80. When the degree of polymerization is 5 or more, mechanical strength is exhibited which is sufficient for the polymer electrolyte for a fuel cell. When the degree of polymerization is 100 or less, the polymer electrolyte can be easily produced.

In this way, in the electrolyte membrane used in the MEA according to the present invention, the polymer electrolyte preferably has a segment having an ion-exchange group, which has the structural unit represented by any one of the formulas (1a) to (4a), and a segment having substantially no ion-exchange groups, which has the structural unit represented by any one of the formulas (1a) to (4a). A block copolymer is preferable in consideration of easy production of the polymer electrolyte. Examples of the suitable combination of the segments include the combinations of segments shown in <A> to <H> of Table 1.

TABLE 1

| | Structural unit | Structural unit |
|---|---|---|
| | constituting | constituting segment |
| Block | segment having an | having substantially no |
| copolymer | ion-exchange group | ion-exchange groups |
| <A> | (1a) | (1b) |
| <B> | (1a) | (3b) |
| <C> | (2a) | (1b) |
| <D> | (2a) | (3b) |
| <E> | (3a) | (1b) |
| <F> | (3a) | (3b) |
| <G> | (4a) | (1b) |
| <H> | (4a) | (3b) |

Among these, <B>, <C>, <D>, <G>, or <H> is more preferable and <G> or <H> is still more preferable.

Specifically, suitable examples of the block copolymer includes block copolymers comprising a segment (a segment having an ion-exchange group) having one or more repeating units selected from the repeating units having an ion-exchange group described below and a segment (a segment having substantially no ion-exchange groups) having one or two or more species of repeating units selected from the repeating units having no ion-exchange groups described below. For example, in the repeating units having an ion-exchange group described below, the ion-exchange group is a sulfo group.

Both segments may be directly bonded to each other or may be bonded via an appropriate atom or a group of atoms. Typical examples of the atom or group of atoms bonding the segments include a bivalent aromatic group, an oxygen atom, a sulfur atom, a carbonyl group, a sulfonyl group, and a bivalent group as a combination thereof.

### (Repeating Units Having Ion-Exchange Group)

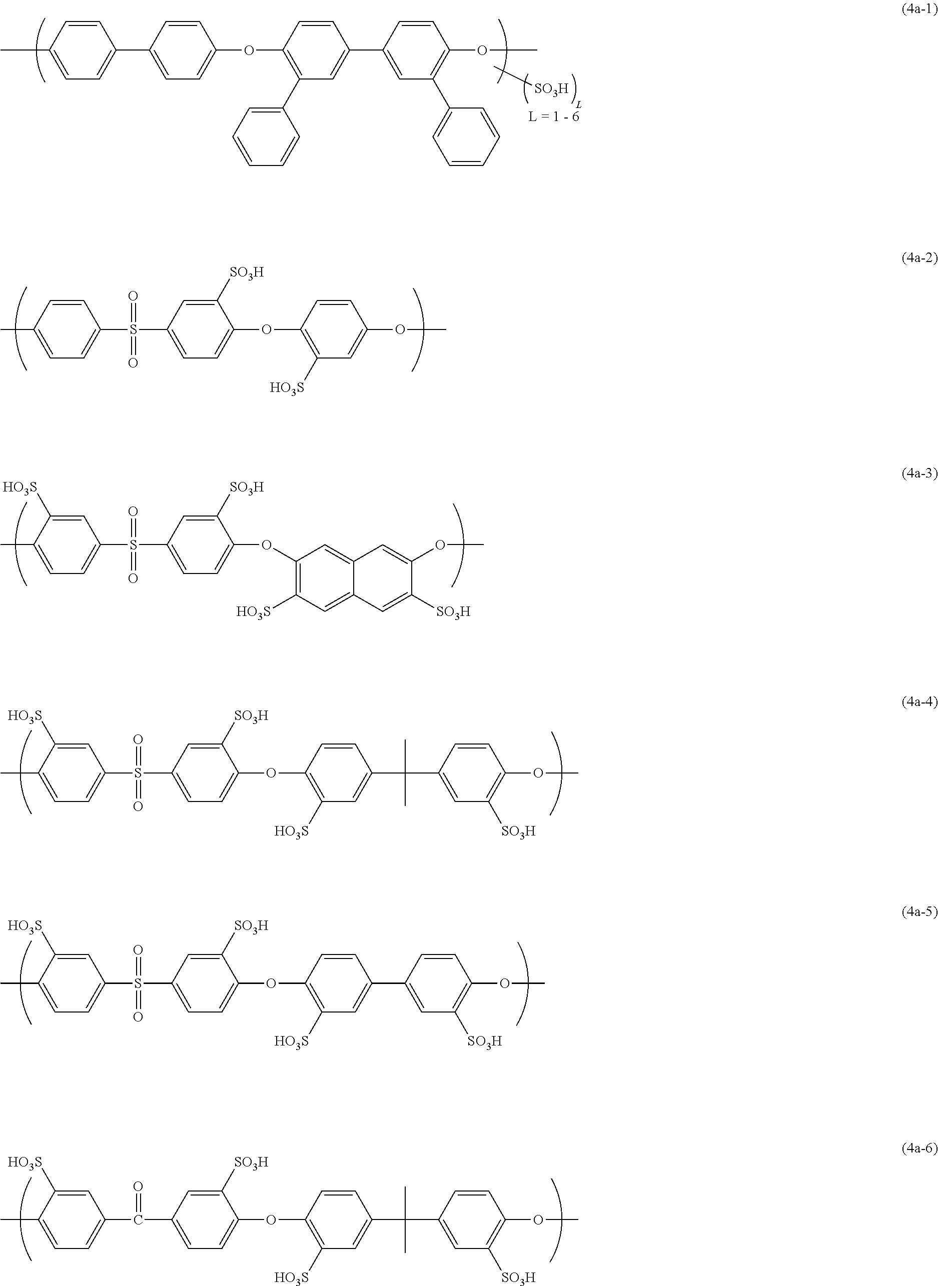

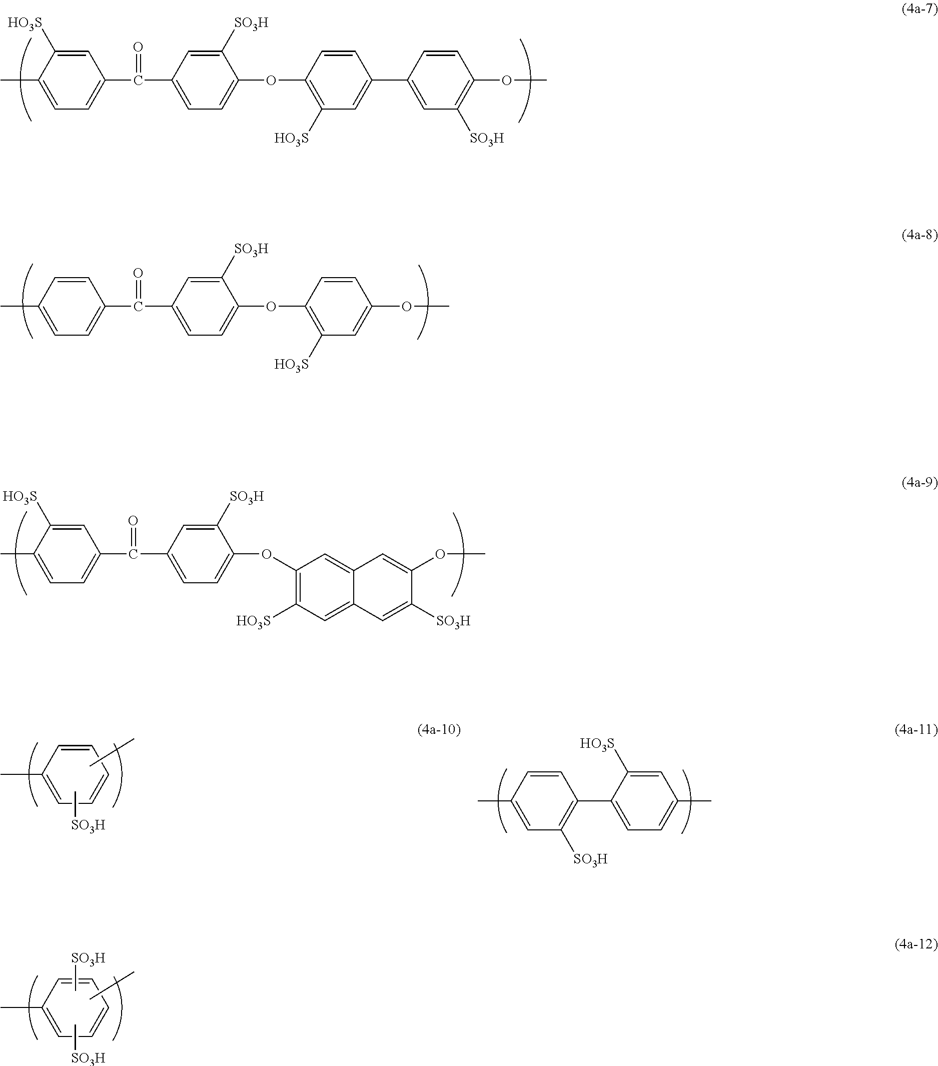

### (Repeating Units Having No Ion-Exchange Groups)

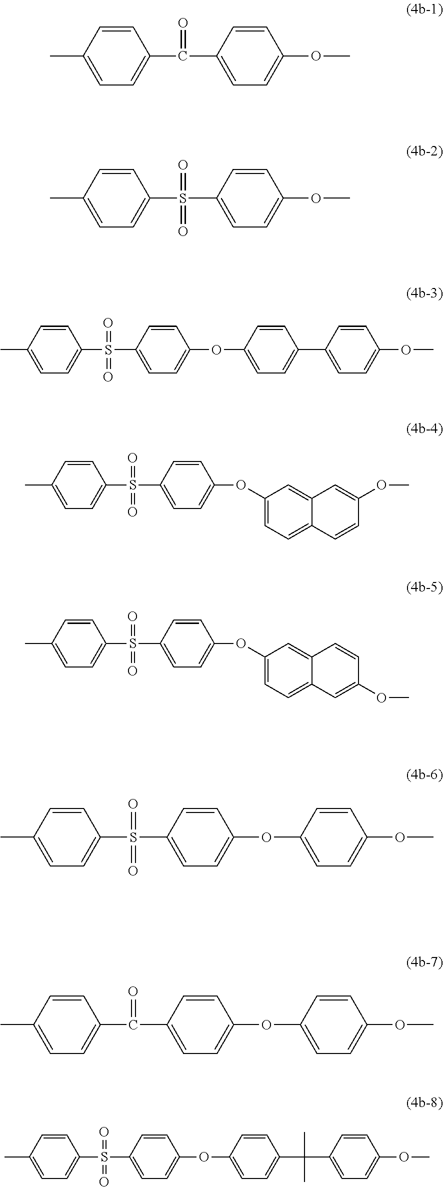

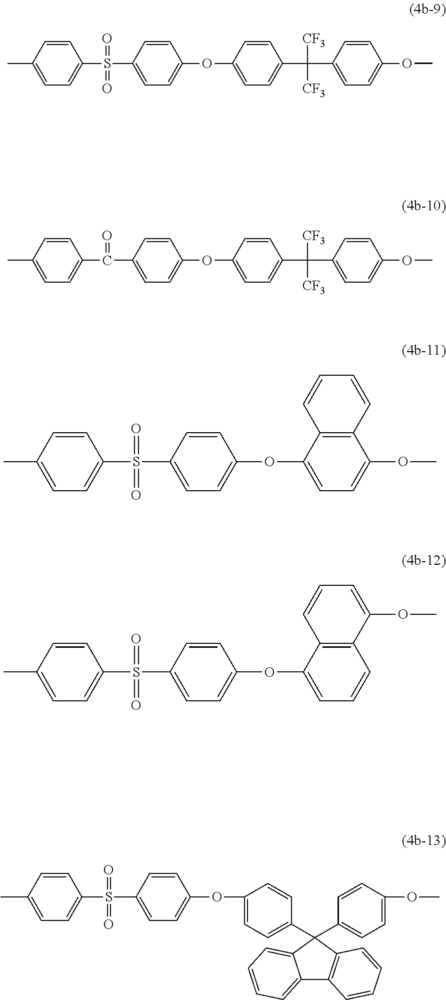

Among these examples, (4a-10) and/or (4a-11) and/or (4a-12) are preferable as the repeating unit constituting the segment having an ion-exchange group and (4a-11) and/or (4a-12) are particularly preferable. The polymer electrolyte having the segment comprising such a repeating unit, particularly, the polymer electrolyte having the segment comprising such a repeating unit, exhibits superior ion conductivity and exhibits relatively superior chemical stability because the segment has polyarylene structure. (4b-2), (4b-3), (4b-10) and (4b-13) are particularly preferable as the repeating unit constituting the segment having no ion-exchange groups.

When a polymer electrolyte membrane is formed by using a solution casting method to be described later, a polymer electrolyte which can form a membrane having both a domain having an ion-exchange group that contributes to the proton conductivity and a domain having substantially no ion-exchange groups that contribute to the mechanical strength, that is, a polymer electrolyte in which the domains can form the phase-separated structure, is preferable. A polymer electrolyte which can form a membrane having a microphase-separated structure is more preferable. Here, the “microphase-separated structure” means a structure in which a phase (domain) in which the density of the segment having an ion-exchange group is higher than the density of the segment having substantially no ion-exchange groups and a phase (domain) in which the density of the segment having substantially no ion-exchange groups is higher than the density of the segment having an ion-exchange group coexist and in which the domain width of the respective domain, that is, the identity period, is in the range of several nm to several hundreds of nm, for example, when it is viewed with a transmissive electron microscope (TEM). Preferably, the microphase-separated structure has a domain structure with a domain width of 5 nm to 100 nm. A block copolymer or a graft copolymer having both the segment having an ion-exchange group and the segment having substantially no ion-exchange groups is preferable, since the microphase-separation in a nano-meter size can be easily generated due to the chemical bond between the heterogeneous segments and a membrane having such a microphase-separated structure can be easily obtained.

Representative examples of the particularly suitable block copolymer include block copolymers having an aromatic polyether structure and comprising both the block (segment) having an ion-exchange group and the block (segment) having substantially no ion-exchange groups, which are described in JP-2005-126684-A or JP-2005-139432-A; and block copolymers having a polyarylene block having an ion-exchange group, which are described in JP-2007-177197-A.

The suitable range of the molecular weight of the polymer electrolyte varies depending on the structures thereof or the like, but the molecular weight of the polymer electrolyte is preferably in the range of 1000 to 2000000 in terms of polystyrene-equivalent number average molecular weight using a GPC (Gel Permeability Chromatography) method. The lower limit of the number average molecular weight is preferably 5000 or more and more preferably 10000 or more. The upper limit of the number-average molecular weight is preferably 1000000 or less and more preferably 500000 or less.

### <Polymer Electrolyte Membrane>

The polymer electrolyte membrane according to the present invention is preferably substantially nonporous so as to set the oxygen permeability coefficient to the above-mentioned range. A porous polymer electrolyte membrane can easily transmit oxygen and thus cannot satisfy the range of the oxygen permeability coefficient. A polymer electrolyte membrane produced by a solution casting method comprising steps (i) to (iv) below is preferable as such a substantially nonporous polymer electrolyte membrane:

(i) a step of dissolving the above-mentioned polymer electrolyte in an organic solvent capable of dissolving the polymer electrolyte to prepare a polymer electrolyte solution;

(ii) a step of casting the polymer electrolyte solution obtained in the step (i) onto a support substrate having a relatively smooth surface to form a cast polymer electrolyte membrane on the support substrate;

(iii) a step of removing the organic solvent from the cast polymer electrolyte membrane formed on the support substrate in the step (ii) to form a polymer electrolyte membrane on the support substrate; and

(iv) a step of separating the polymer electrolyte membrane from the support substrate after performing the step (iii).

The steps (i) to (iv) of the solution casting method will be sequentially described below.

First, in the step (i), the polymer electrolyte solution is prepared as described above. As the organic solvent to be used to prepare the polymer electrolyte solution, a solvent capable of dissolving one or two or more species of polymer electrolytes to be used is selected. When other components such as polymers other than the polymer electrolyte or additives are used in addition to the polymer electrolyte, the solvent can preferably dissolve all the other components.

The organic solvent is a solvent which can dissolve the polymer electrolyte to be used, and specifically means an organic solvent which can dissolve the polymer electrolyte in a concentration of 1 wt % or more at 25° C. Preferably, an organic solvent which can dissolve the polymer electrolyte in the concentration range of 5 to 50 wt % is used.

When two or more species of polymer electrolytes are used as the polymer electrolyte, an organic solvent which can dissolve the polymer electrolytes in a concentration of 1 wt % or more in total is used and an organic solvent which can dissolve the polymer electrolytes in the concentration range of 5 to 50 wt % in total is preferably used. The organic solvent preferably has volatility to such an extent that it can be removed through heating treatment after the cast polymer electrolyte membrane is formed on the support substrate. Here, the organic solvent preferably includes at least one species of organic solvent of which the boiling point at 101.3 kPa (1 atm) is equal to or higher than 150° C. When only an organic solvent of which the boiling point is equal to or lower than 150° C. is used as the organic solvent which can dissolve the polymer electrolyte and it is intended to remove the organic solvent from the cast polymer electrolyte membrane in the step (iii) to be described later and to form a polymer electrolyte membrane, defective appearance such as unevenness may occur in the formed polymer electrolyte membrane. This is because the organic solvent is rapidly volatilized from the cast polymer electrolyte membrane in the organic solvent of which the boiling point is equal to or higher than 150° C.

Examples of the organic solvent suitable for preparing the polymer electrolyte solution include aprotic polar solvents such as dimethylformamide (DMF), dimethylacetamide (DMAc), N-methyl-2-pyrrolidone (NMP), dimethyl sulfoxide (DMSO), and γ-butyrolactone (GBL), chlorine-based solvents such as dichloromethane, chloroform, 1,2-dichloroethane, chlorobenzene, and dichlorobenzene, alcohols such as methanol, ethanol, and propanol, and alkylene glycol monoalkyl ethers such as ethylene glycol monomethyl ether, ethylene glycol monoethyl ether, propylene glycol monomethyl ether, and propylene glycol monoethyl ether. These solvents may be used alone or in combination of two or more species if necessary. Among these, the organic solvents including an aprotic polar solvent are preferable and the organic solvents substantially formed of an aprotic polar solvent are more preferable. Here, the organic solvent substantially formed of an aprotic polar solvent does not exclude presence of moisture included unintentionally. The aprotic solar solvent has a merit that the affinity for the support substrate is relatively small and the aprotic solar solvent is not easily absorbed by the support substrate. In view of high solubility of the block copolymer which is the above-mentioned polymer electrolyte, DMSO, DMF, DMAc, NMP, and GBL or a mixed solvent of two or more species selected therefrom are preferable among the aprotic solar solvents.

The step (ii) will be described below.

This step is a step of casting the polymer electrolyte solution obtained in the step (i) onto the support substrate. Examples of the casting method include various means such as a roller coating method, a spray coating method, a curtain coating method, a slot coating method, and a screen printing method and means for shaping the cast polymer electrolyte membrane with predetermined width and thickness by the use of a mold called a die having a predetermined clearance can be preferably used. The cast polymer electrolyte membrane formed on the support substrate in this way has a film shape because a part of the organic solvent in the polymer electrolyte solution is volatilized during the coating. The thickness of the cast polymer electrolyte membrane is preferably in the range of 3 to 50 μm. To obtain the cast polymer electrolyte membrane with such a thickness, the concentration of the polymer electrolyte in the polymer electrolyte solution to be used, the amount of dose from the coater, and the like may be appropriately adjusted. When the support substrate is a substrate continuously conveying, the conveying speed of the support substrate may be adjusted.

Regarding the support substrate used in the step (ii), a material having satisfactory durability to the polymer electrolyte solution used for the casting method and satisfactory durability to the process conditions in the step (iii) to be described later is selected. The durability means that the support substrate itself is not substantially eluted by the polymer electrolyte solution or that the support substrate itself does not swell or contract depending on the process conditions of the step (iii) and has size stability.

Examples of the support substrate include a glass plate; metal foils such as a SUS foil and a copper foil; and plastic films such as a polyethylene terephthalate (PET) film and a polyethylene naphthalate (PEN) film. The surfaces of the plastic films may be subjected to surface treatment such as a UV process, a releasing process, and an embossing process without markedly damaging the durability.

The step (iii) will be described below.

This step is a step of removing the organic solvent included in the cast polymer electrolyte membrane formed on the support substrate in the step (ii) and forming a polymer electrolyte membrane on the support substrate. Drying or washing using a washing solvent can be recommended for the removal. It is more preferable that the drying and the washing be combined to remove the organic solvent. When the drying and the washing are combined, it is particularly preferable that most of the organic solvent included in the cast polymer electrolyte membrane formed on the support substrate is removed by the drying and then the washing using a washing solvent is performed.

The method of sequentially performing the drying and the washing, which is suitable for the step (iii), will be described in detail below. To dry and remove the organic solvent from the cast polymer electrolyte membrane formed on the support substrate in the step (ii), processes such as heating, depressurization, and ventilation can be employed, but the heating process is preferable in view of superior productivity and easy operation. In this case, the support substrate (hereinafter sometimes referred to as a “first laminated film”) having the cast polymer electrolyte membrane formed thereon is heated through direct heating, hot air contact, and the like. The hot air process is particularly preferable from the viewpoint that the polymer electrolyte in the cast polymer electrolyte membrane is not markedly damaged. For example, when the first laminated film has a long shape and the first laminated film having a long shape is continuously processed, the first laminated film is made to pass through a drying furnace. In this case, the drying furnace blows hot air set to a temperature in the range of 40° C. to 150° C. and more preferably in the range of 50° C. to 140° C. in a direction perpendicular to the passing direction of the first laminated film and/or a counter direction thereof. Accordingly, the volatile component such as the organic solvent is removed (volatilized) from the cast polymer electrolyte membrane on the support substrate to form a second laminated film in which a polymer electrolyte membrane is formed on the support substrate.

Since a small amount of organic solvent is included yet in the polymer electrolyte membrane of the resultant second laminated film, this organic solvent is washed with a washing solvent. By washing with the washing solvent, a polymer electrolyte membrane having excellent appearance or the like tends to be obtained. When DMSO, DMF, DMAc, NMP, and GBL or a mixed solvent of two or more species selected therefrom are used as the organic solvent suitable for preparing the polymer electrolyte solution, pure water, particularly, ultra-pure water, can be preferably used as the washing solvent.

As described above, when the first laminated film has a long shape and conveys continuously, the second laminated film continuously formed by passing through the drying furnace can be washed, for example, by passing through a washing tank filled with the washing solvent. The washing may be performed by winding the second laminated film continuously formed by passing through the drying furnace on an appropriate winding core to form a wound body, then transferring the wound body to a washing apparatus performing a washing process, and sending the second laminated film to the washing tank from the wound body. Accordingly, it is possible to further reduce the content of the organic solvent in the polymer electrolyte membrane of the second laminated film.

By removing the support substrate from the resultant second laminated film through the peeling or the like, a polymer electrolyte membrane is obtained. Since this polymer electrolyte membrane is obtained by the solution casting method, it is substantially nonporous. Here, the “substantially non porous” means that through-holes including micro through-holes such as voids are not present in the polymer electrolyte membrane. However, the polymer electrolyte membrane may include voids, as long as the number or the size of voids is small enough to set the oxygen permeability coefficient to the above-mentioned range.

It is stated in producing a polymer electrolyte membrane using the solution casting method that the support substrate conveys continuously, but it is possible to obtain a polymer electrolyte membrane even when individual support substrates are used. In this case, the organic solvent can be removed from the polymer electrolyte solution applied on the individual support substrates by storing them in an appropriate drying furnace, and the resultant individual second laminated films can be subjected to a washing process by immersing the second laminated films in a washing tank filled with a washing solvent.

The support substrates may be removed from washed second laminated films and then the washing solvent remaining therein or attached thereto may be removed by drying, or the washing solvent remaining therein or attached thereto may be removed by heating the washed second laminated film and then the support substrates may be removed.

The method of producing a substantially nonporous polymer electrolyte membrane using the solution casting method has been described hitherto, but a component (an additional component) other than the polymer electrolyte may be included in the polymer electrolyte membrane, as described above.

Examples of the additional component include additives such as a plasticizer, a stabilizer, a release agent, and a water retention agent which are usually used in polymers and the stabilizer is particularly preferable. Peroxides may be generated in the catalyst layer of a fuel cell during operation, the peroxides may diffuse into the electrolyte membrane and may be changed to radical species, and the radical species may degrade the polymer electrolyte constituting the polymer electrolyte membrane. To avoid this problem, a stabilizer which can give radical resistance can be preferably added to the electrolyte membrane. Examples of the appropriate stabilizer include stabilizers which can enhance the chemical stability such as oxidation resistance and radical resistance.

These additional components can be added to the polymer electrolyte solution when preparing the polymer electrolyte solution used in the solution casting method. By this process, it is possible to obtain a substantially nonporous polymer electrolyte membrane even when the additional components are used.

The water vapor permeability coefficient of the polymer electrolyte membrane according to the present invention from a first surface to a second surface thereof which is measured in a state where the first surface is exposed to a humidified environment of a temperature of 85° C. and a relative humidity of 20% and the second surface is exposed to a non-humidified environment of a temperature of 85° C. and a relative humidity of 0% is equal to or higher than 7.0×10⁻¹⁰ mol/sec/cm. Alternatively, the water vapor permeability from the first surface to the second surface which is measured in a state where the first surface of the polymer electrolyte membrane is exposed to a humidified environment of a temperature of 85° C. and a relative humidity of 20% and the second surface is exposed to a non-humidified environment of a temperature of 85° C. and a relative humidity of 0% is equal to or higher than 1.0×10⁻⁶ mol/sec/cm². The “relative humidity of 0%” means that the dew point measured using a dew-point meter is equal to or lower than −25° C. The present inventors found that a polymer electrolyte membrane having more excellent electric power generation performance is obtained by improving the water vapor permeability. As the water vapor permeability coefficient thereof becomes higher, it is possible to implement a fuel cell having more excellent electric power generation performance. Examples of the method of raising the water vapor permeability coefficient or the water vapor permeability include a method of raising the density of the ion-exchange group for each repeating unit having the ion-exchange group and a method of raising the degree of ionic dissociation (acid strength) of the ion-exchange group, in addition to a method of reducing the thickness of the polymer electrolyte membrane and a method of raising the ion exchange capacity (IEC). In a specific method of enhancing the acid strength, strong acidic groups such as a sulfo group and a sulfanilamide group is used as the ion-exchange group to be introduced. Alternatively, since the degree of ionic dissociation of the ion-exchange group varies depending on an adjacent aromatic group or substituent group and the degree of ionic dissociation becomes higher as the electron-attracting property of the substituent group becomes higher, the degree of ionic dissociation of the ion-exchange group can be raised by introducing an electron-attracting substituent group into the repeating unit having an ion-exchange group. Here, the “electron-attracting substituent group” is a group of which the a value in the Hammett rule is positive. The water vapor permeability coefficient is more preferably equal to or greater than 1.0×10⁻⁹ mol/sec/cm. Since the polymer electrolyte membrane according to the present invention is substantially nonporous, the enhancement of the water vapor permeability coefficient is limited. In consideration of the practical strength thereof or the like, the water vapor permeability coefficient is preferably equal to or less than 1.0×10⁻⁶ mol/sec/cm. Measurement of the water vapor permeability coefficient will be described in detail below. First, carbon separators (with a gas flow area of 1.3 cm²) having grooves for a gas flow channel formed therein are disposed on both sides of a polymer electrolyte membrane used for the measurement, and electricity collectors and end plates are sequentially disposed thereon. A silicone gasket having apertures with 1.3 cm² and the same shape as the gas flow channel of the separator is disposed between the polymer electrolyte membrane and the carbon separators. By fastening these with bolts, a cell for measuring the water vapor permeability is assembled. Hydrogen gas with a relative humidity of 20% is made to flow on one side of the cell at a flow rate of 1000 mL/min and air with a relative humidity of 0% is made to flow on the other side at a flow rate of 200 mL/min. In this case, the back pressures on both sides are set to 0.04 MPa. By disposing a dew-point thermometer at an air outlet and measuring the dew point of the outlet gas, the amount of moisture included in the outlet air is measured and the water vapor permeability (mol/sec/cm²) is calculated from the measured amount of moisture. By multiplying the water vapor permeability by the thickness of the polymer electrolyte membrane, the water vapor permeability coefficient (mol/sec/cm) is calculated.

The polymer electrolyte membrane according to the present invention is substantially nonporous and the permeability coefficient (oxygen permeability coefficient) of oxygen which can be calculated in this way is equal to or less than 1.0×10⁻⁹ cc·cm/cm²·sec·cmHg.

### [Oxygen Permeability Coefficient]

The oxygen permeability coefficient from the first surface to the second surface is measured in a state where the first surface of the polymer electrolyte membrane is exposed to a humidified environment of a temperature of 85° C. and a relative humidity of 20% and the second surface is exposed to a non-humidified environment of a temperature of 85° C. and a relative humidity of 0%. In this case, a cell having the same structure as described in the measurement of the water vapor permeability coefficient is assembled, oxygen gas is made flow on one side of the cell, and helium gas is made to flow on the other side. Then, the oxygen permeability (cc/m²·24 h·atm) to be described later is measured through an isopiestic method using a gas permeability measuring instrument (type: GTR-30×AF3SC, made by GTR Tec Corporation) and the measured oxygen permeability is multiplied by the thickness of the polymer electrolyte membrane, whereby the oxygen permeability coefficient (cc·cm/cm²·sec·cmHg) can be calculated. The temperature of the cell of which the polymer electrolyte membrane is left is set to 85° C., the relative humidity of the oxygen gas side is set to 20%, and the relative humidity of the measurement side (the helium gas side) is set to about 0%.

To obtain a polymer electrolyte membrane of which the water vapor permeability coefficient and the oxygen permeability coefficient are set to the above-mentioned range of the present invention and which has satisfactory mechanical strength during the absorption of moisture and an appropriate thickness, it is very important to maintain the environmental temperature in a predetermined range when producing a polymer electrolyte membrane using the solution casting method. Specifically, the error of the environmental temperature is preferably maintained in ±2° C. For the purpose of maintaining the environmental temperature, the steps (i) to (iv) based on the solution casting method can be performed in a constant-temperature chamber which is maintained at a constant temperature. Although depending on the type of the polymer electrolyte used, the environmental temperature of the constant-temperature chamber is preferably in the range of 23° C.±2° C. To obtain a polymer electrolyte membrane with a small thickness, it is more preferable that the environmental humidity be maintained in a constant range, and the environmental humidity is preferably in the range of 40 to 60% RH. For the purpose of maintaining the environmental humidity, the steps (i) to (iv) based on the solution casting method can be performed in a constant-temperature and constant-humidity chamber. To efficiently produce a substantially nonporous polymer electrolyte membrane, floating materials such as dust are preferably excluded from the environment. Accordingly, it is preferable that the polymer electrolyte membrane be produced in a clean room of about class 10000 in which the temperature is controlled in the range of 23° C.±2° C. and the humidity is controlled in the range of 40 to 60% RH.

The polymer electrolyte membrane according to the present invention has a breaking stress equal to or greater than 20 MPa in a tension test executed at a temperature of 80° C. and a relative humidity of 90% on the basis of JIS K-7127.

The polymer electrolyte membrane according to the present invention is nonporous enough to satisfy the above-mentioned oxygen permeability coefficient, has a high water vapor permeability coefficient, and has high mechanical strength when the polymer electrolyte membrane absorbs moisture. These characteristics will be described in terms of the water vapor permeability and/or the oxygen permeability. The “water vapor permeability” means an amount of water vapor per unit time and per unit area passing from the first surface to the second surface per unit time and per unit area in the same environment as the measurement of the water vapor permeability coefficient, that is, in the state where the first surface of the polymer electrolyte membrane is exposed to a humidified environment of a temperature of 85° C. and a relative humidity of 20% and the second surface is exposed to a non-humidified environment of a temperature of 85° C. and a relative humidity of 0%. The water vapor permeability is preferably equal to or greater than 1.0×10⁻⁶ mol/sec/cm² and more preferably equal to or greater than 1.5×10⁻⁶ mol/sec/cm².

On the other hand, the “oxygen permeability” means an amount of oxygen passing from the first surface to the second surface in the same environment as the measurement of the oxygen permeability coefficient, that is, in the state where the first surface of the polymer electrolyte membrane is exposed to a humidified environment of a temperature of 85° C. and a relative humidity of 20% and the second surface is exposed to a non-humidified environment of a temperature of 85° C. and a relative humidity of 0%. The oxygen permeability is preferably equal to or less than 7.0×10⁴ cc/m²·24 h·atm which means nonporous and more preferably equal to or less than 5.0×10⁴ cc/m²·24 h·atm. The temperature of the cell of which the polymer electrolyte membrane is left is set to 85° C., the relative humidity of the oxygen gas side is set to 20%, and the relative humidity of the measurement side (the helium gas side) is set to about 0%.

### <Solid Polymer Fuel Cell>

Finally, a fuel cell employing the polymer electrolyte membrane according to the present invention will be described in brief.

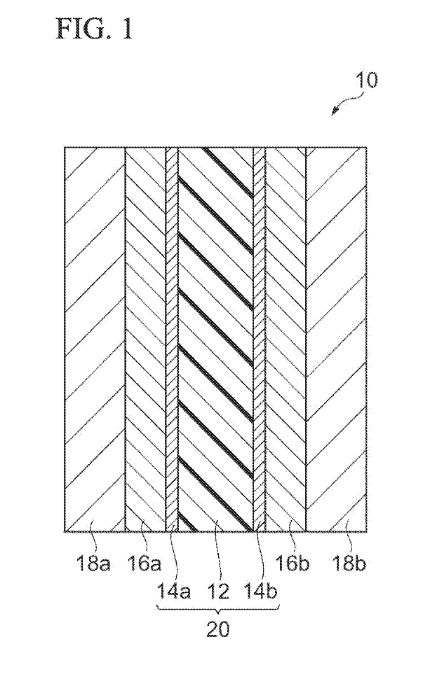

FIG. 1 is a diagram schematically illustrating the sectional configuration of a fuel cell according to a preferred embodiment of the present invention. As shown in FIG. 1, in a fuel cell 10, an anode catalyst layer 14a and a cathode catalyst layer 14b are disposed on both sides of the electrolyte membrane 12 (proton-conducting membrane) with the electrolyte membrane interposed therebetween, and gas diffusion layers 16a and 16b and separators 18a and 18b are sequentially formed on both catalyst layers. The electrolyte membrane 12 and both catalyst layers 14a and 14b with the electrolyte membrane interposed therebetween constitute a membrane-electrode assembly (hereinafter sometimes referred to as “MEA”) 20.

The MEA 20 having the above-mentioned configuration can exhibit such excellent high-temperature electric power generation performance that the temperature at which the voltage is less than 0.1 V is equal to or higher than 85° C. when an electric power generation test is executed under the following conditions. The temperature at which the voltage is less than 0.1 V under the same conditions is more preferably equal to or higher than 90° C.

### [Electric Power Generation Test]

A carbon paper as a gas diffusion layer and a carbon separator having a groove as a gas flow channel formed through a cutting process are disposed on both sides of the membrane-electrode assembly, an electricity collector and an end plate are sequentially disposed thereon, and these constituents are fastened with bolts, whereby a fuel cell with an effective electrode area of 1.3 cm² is assembled. Subsequently, this fuel cell is maintained at 60° C., humidified hydrogen is supplied to the anode, and humidified air is supplied to the cathode. The back pressure at the gas outlet of the cell is set to 0.1 MPaG for both electrodes. The source gas is humidified at a water temperature of a hydrogen bubbler of 45° C. and at a water temperature of an air bubbler of 55° C., the gas flow rate of hydrogen is set to 335 mL/min, and the gas flow rate of air is set to 1045 mL/min. The temperature at which the voltage is less than 0.1 V is measured while drawing current of 1.6 A/cm² and raising the temperature of the fuel cell.

The gas diffusion layers 16a and 16b are disposed to interpose both sides of the MEA 20 therebetween and serve to promote the diffusion of the source gas into the catalyst layers 14a and 14b. The gas diffusion layers 16a and 16b are preferably formed of a porous material having electron conductivity. The carbon paper or the like described as the substrate in the method (b) of producing a catalyst layer is used and a material which can efficiently transport the source gas to the catalyst layers 14a and 14b is selected.

A membrane-electrode-gas diffusion layer assembly (MEGA) is constituted by the electrolyte membrane 12, the catalyst layers 14a and 14b, and the gas diffusion layers 16a and 16b.

The separators 18a and 18b are formed of a material having electron conductivity and examples thereof include carbon, resin-molded carbon, titanium, and stainless steel. Although not shown, grooves serving as a flow channel for supplying fuel gas to the anode-side catalyst layer 14a and supplying oxidant gas to the cathode-side catalyst layer 14b are formed in the separators 18a and 18b.

The fuel cell 10 is obtained by bonding the MEGA and a pair of separators 18a and 19b with the MEGA interposed between the separators.

In the fuel cell 10, the above-mentioned structure may be sealed with a gas sealing member or the like. Plural fuel cells 10 having this structure may be connected in series and may be provided as a fuel cell stack for practical use. The fuel cell having this configuration can be used as a solid polymer fuel cell when the fuel is hydrogen and as a direct methanol type fuel cell when the fuel is a methanol aqueous solution.

While the preferred embodiment of the present invention has been described, the present invention is not limited to the preferred embodiment.

### EXAMPLES

Hereinafter, examples and comparative examples of the present invention will be described in detail but the present invention is not limited to the examples.

### [Measurement of Water Vapor Permeability]

Carbon separators (with a gas flow area of 1.3 cm²) having grooves for a gas flow channel formed therein by cutting were disposed on both sides of a polymer electrolyte membrane and electricity collectors and end plates were sequentially disposed thereon. A silicone gasket having apertures with 1.3 cm² and the same shape as the gas flow channel of the separators was disposed between the polymer electrolyte membrane and the carbon separators. By fastening these with bolts, a cell for measuring the water vapor permeability was assembled.

The temperature of the cell was set to 85° C., hydrogen gas with a relative humidity of 20% was made to flow on one side of the cell at a flow rate of 1000 mL/min, and air with a relative humidity of 0% was made to flow on the other side at a flow rate of 200 mL/min. The back pressures on both sides were set to 0.04 MPa. By disposing a dew-point thermometer at an air outlet and measuring the dew point of the outlet gas, the amount of moisture included in the outlet air was measured and the water vapor permeability coefficient (mol/sec/cm) and the water vapor permeability (mol/sec/cm²) were calculated.

### [Measurement of Oxygen Permeability]

The oxygen permeability coefficient (cc·cm/cm²·sec·cmHg) and the oxygen permeability (cc/m²·24 h·atm) were measured through an isopiestic method using a gas permeability measuring instrument (type: GTR-30×AF3SC, made by GTR Tec Corporation). The temperature of the cell of which the polymer electrolyte membrane was left was set to 85° C., the relative humidity of the oxygen gas side was set to 20%, and the relative humidity of the measurement side (the helium gas side) was set to about 0%.

### [Tension Test]

The breaking stress of the polymer electrolyte membrane was measured through a tension test based on the JIS K-7127. Specifically, a environment-controlled tension test machine (made by Illinois Tool Works Inc.) was used. The polymer electrolyte membrane which was exposed to the environment of a temperature of 80° C. and a relative humidity of 90% for 2 hours or more was pulled at a pulling rate of 10 mm/min to execute the tension test, whereby the breaking stress was measured.

### [Measurement of Molecular Weight]

By measuring the molecular weight using the gel permeability chromatography (GPC) method under the following conditions and converting to polystyrene-equivalent, the weight average molecular weight and the number average molecular weight of the polymer electrolyte membrane were calculated.

### GPC Conditions

Measuring Instrument: Prominence GPC System, made by Shimadzu Corporation

Column: TSKgel GMH_{HR-M}, made by Tosoh Corporation

Column Temperature: 40° C.

Mobile-phase Solvent: N,N-dimethylformamide (including 10 mmol/dm³ of LiBr)

Solvent Flow Rate: 0.5 mL/min

### [Measurement of Ion Exchange Capacity]

A polymer film formed of a polymer according to the solution casting method to be provided for the measurement was obtained and the obtained polymer film was cut to have an appropriate weight. The dry weight of the cut polymer film was measured by the use of a halogen moisture meter of which the heating temperature was set to 110° C. Subsequently, the dried polymer film was immersed in 5 mL of a 0.1 mol/L sodium hydroxide aqueous solution, 50 mL of ion-exchange water was added thereto, and the resultant was left for 2 hours. Thereafter, the solution in which the polymer film was immersed titrated by slowly adding a 0.1 mol/L hydrochloric acid thereto, whereby the point of neutralization was obtained. The ion exchange capacity (unit: meq/g) of the polymer was calculated from the dry weight of the cut polymer film and the amount of the hydrochloric acid used for the neutralization.

### [Preparation of Catalyst Ink]

0.50 g of platinum-supported carbon (product name: SA50BK, made by N.E. Chemcat Corporation) supporting 50 wt % platinum was put to 3.15 g of a 5 wt % Nafion (registered trademark of Du Pont de Nemours & Co.) solution (solvent: mixture of water and lower alcohol, made by Aldrich Chemical Co., Inc.) commercially available, and 3.23 g of water and 21.83 g of ethanol were added thereto. The resultant mixture was subjected to an ultrasonic process for 1 hour and was stirred with a stirrer for 6 hours, whereby a catalyst ink was obtained.

### [Preparation of MEA]

The catalyst ink was applied to an area of 1 cm×1.3 cm at the center of one surface of a polymer electrolyte membrane to be described later according to a spray method. At this time, the distance from the ejection nozzle to the membrane was set to 6 cm and the stage temperature was set to 75° C. The catalyst ink was additionally applied in the same way and the solvent was removed to form an anode catalyst layer. 2.1 mg of solid (platinum content: 0.6 mg/cm²) was applied as the anode catalyst. Subsequently, the catalyst ink was applied to the other surface in the same way to form a cathode catalyst layer, whereby MEA 1 was obtained. A solid content of 2.1 mg (with a platinum content of 0.6 mg/cm²) was applied as the cathode catalyst layer.

### [Assembly of Fuel Cell]

Carbon cloths as a gas diffusion layer and carbon separators having grooves for a gas flow channel formed therein by cutting were disposed on both sides of the resultant MEA 1, electricity collectors and end plates were sequentially disposed thereon, and these were fastened with bolts, whereby a fuel cell with an effective electrode area of 1.3 cm² was assembled.

### [Evaluation of Electric Power Generation Performance]

The resultant fuel cell was maintained at 60° C., humidified gas was supplied to the anode, and humidified air was supplied to the cathode. The back pressures at the gas outlet of the cell were set to 0.04 MPa for both electrodes. The source gas was humidified by causing the source gas to pass through a bubbler containing water, the water temperature of a hydrogen bubbler was set to 45° C., and the water temperature of an air bubbler was set to 55° C. Here, the gas flow rate of hydrogen was set to 335 mL/min and the gas flow rate of air was set to 1045 mL/min. The temperature at which the voltage was less than 0.1 V was measured while drawing current of 1.6 A/cm² and raising the temperature of the fuel cell.

### Synthesis Example 1

Polymer Electrolyte 1 having the structure below was synthesized using SUMIKAEXCEL PES 3600P (Mn=2.7×10⁴ and Mw=4.5×10⁴) made by Sumitomo Chemical Co., Ltd. instead of SUMIKAEXCEL PES 5200P (Mn=5.4×10⁴ and Mw=1.2×10⁵) made by Sumitomo Chemical Co., Ltd. with reference to the methods described in JP-2007-177197-A and JP-2007-284653-A.

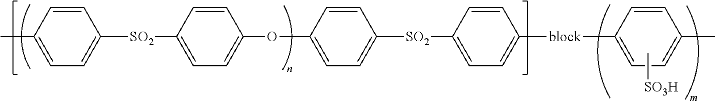

Mn=1.6×10⁵

Mw=3.3×10⁵

Ion exchange capacity (IEC)=2.7 meq/g

### Synthesis Example 2

In the atmosphere of nitrogen, 10.2 g (54.7 mmol) of 4,4′-dihydroxy-1,1′-biphenyl, 8.32 g (60.2 mmol) of potassium carbonate, 96 g of N,N-dimethylacetamide, and 50 g of toluene were put into a flask having an azeotropic distillation apparatus. The moisture of the system was azeotropically removed by heating toluene to reflux at a bath temperature of 155° C. for 2.5 hours. The toluene and the generated water were distilled away, the resultant mixture was cooled at the room temperature, and 22.0 g (76.6 mmol) of 4,4′-dichlorodiphenyl sulfone was added thereto, whereby a mixture was obtained. The bath temperature was raised to 160° C. and the mixture was stirred while maintaining the temperature for 14 hours. After cooling the resultant, the reactant was added to a mixed solution of 1000 g of methanol and 200 g of 35 wt % hydrochloric acid, and the deposited precipitates were collected by filtration, were washed with ion-exchange water until being neutralized, and were then dried. 27.2 g of the resultant crude product was dissolved in 97 g of N,N-dimethylacetamide, insoluble matters were removed by filtration, the filtrate was added to a mixed solution of 1100 g of methanol and 100 g of 35 wt % hydrochloric acid, and the deposited precipitates were collected by filtration, were washed with ion-exchange water until being neutralized, and were then dried, whereby 25.9 g of a precursor polymer for deriving the segment having substantially no ion-exchange groups, which is represented by formula (A-1) below, was obtained.

GPC Molecular Weight: Mn=1700 and Mw=3200

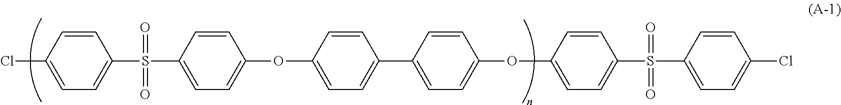

Then, in the atmosphere of argon, a mixture obtained by putting 2.12 g (9.71 mmol) of anhydrous nickel bromide and 96 g of N-methylpyrrolidone into a flask was stirred at a bath temperature of 70° C. After it was confirmed that anhydrous nickel bromide is dissolved, the bath temperature was lowered to 50° C. and 1.82 g (11.7 mmol) of 2,2′-bipyridyl was added thereto, whereby a nickel-containing solution was prepared.

In the atmosphere of argon, 4.02 g of the polymer represented by formula (A-1) above and 384 g of N-methylpyrrolidone were put into a flask and the temperature was adjusted to 50° C. A mixture obtained by adding 3.81 g (58.2 mmol) of zinc particles, 1.05 g of a mixed solution of 1 part by weight of methanesulfonic acid and 9 parts by weight of N-methylpyrrolidone, and 24.0 g (45.9 mmol) of di(2,2-dimethylpropyl) 4,4′-dichlorobiphenyl-2,2′-disulfonate synthesized by the method described in Example 1 of JP-2007-270118-A to the resultant solution was stirred at 50° C. for 30 minutes. The nickel-containing solution was poured into the resultant and the resultant was polymerized at 50° C. for 6 hours, whereby a black polymer solution was obtained.

The obtained polymer solution was put to 3360 g of 13 wt % hydrochloric acid and the resultant was stirred at the room temperature for 30 minutes. The deposited precipitates were collected by filtration, the resultant was added to 3360 g of 13 wt % hydrochloric acid, the resultant was stirred at the room temperature for 30 minutes, and then the resultant was filtrated. The collected solid was washed with ion-exchange water until the pH of the filtrate is higher than 4.840 g of ion-exchange water and 790 g of methanol were added to the obtained crude polymer and the resultant was heated and stirred at a bath temperature of 90° C. for 1 hour. By filtrating and drying the crude polymer, 23.9 g of the polymer having a sulfonic precursor group ((2,2-dimethylpropyl) sulfonate group) was obtained.

The sulfonic precursor group was converted into a sulfo group as follows.

A mixture obtained by putting 23.9 g of the polymer having a sulfonic precursor group obtained as described above, 47.8 g of ion-exchange water, 15.9 g (183 mmol) of anhydrous lithium bromide, and 478 g of N-methylpyrrolidone into a flask was heated and stirred at a bath temperature of 126° C. for 12 hours, whereby a polymer solution was obtained. The obtained polymer solution was added to 3340 g of 13 wt % hydrochloric acid and the resultant was stirred for 1 hour. The deposited crude polymer was collected by filtration, and the process of washing the collected crude polymer with 2390 g of a mixed solution of 10 parts by weight of methanol and 10 parts by weight of 35% hydrochloric acid was repeatedly carried out three times. Thereafter, the crude polymer was washed with ion-exchange water until the pH of the filtrate is higher than 4. Subsequently, a washing process of adding a large amount of ion-exchange water was to the obtained polymer, raising the temperature to 90° C. or higher, maintaining the temperature for about 10 minutes, and filtrating the resultant was repeatedly carried out five times. By drying the resultant polymer, 17.25 g of Polymer Electrolyte 2 represented by formula (A-2) below was obtained.

GPC Molecular Weight: Mn=340000 and Mw=706000

IEC: 4.6 meq/g

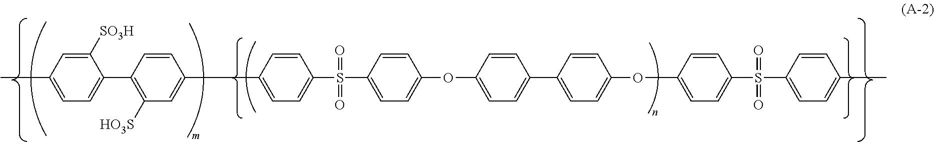

### Synthesis Example 3

In the atmosphere of nitrogen, 14.8 g (42.3 mmol) of 9,9′-bis(4-hydroxyphenyl)fluorene, 6.43 g (46.5 mmol) of potassium carbonate, 95 g of N,N-dimethylformamide, and 48 g of toluene were put into a flask having an azeotropic distillation apparatus. The moisture of the system was azeotropically removed by heating toluene to reflux at a bath temperature of 155° C. for 3 hours. The toluene and the generated water were distilled away and 17.0 g (59.2 mmol) of 4,4′-dichlorodiphenyl sulfone was added to the resultant, whereby a mixture was obtained. The bath temperature was raised to 160° C. and the mixture was stirred while maintaining the temperature for 14 hours. After cooling the resultant, the reactant was added to a mixed solution of 1000 g of methanol and 200 g of 35 wt % hydrochloric acid, and the deposited precipitates were collected by filtration, were washed with ion-exchange water until being neutralized, and were then dried. The resultant crude product was dissolved in 95 g of N,N-dimethylformamide, the resultant solution was added to a mixed solution of 1100 g of methanol and 100 g of 35 wt % hydrochloric acid, and the deposited precipitates were collected by filtration, were washed with ion-exchange water until being neutralized, were washed with 1000 g of methanol, and were then dried, whereby 25.4 g of a precursor polymer for deriving the segment having substantially no ion-exchange groups, which is represented by formula (B-1) below, was obtained.

GPC Molecular Weight: Mn=2000 and Mw=3500

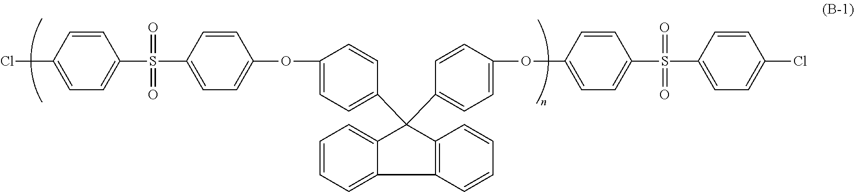

Then, in the atmosphere of argon, a mixture obtained by putting 3.41 g (15.6 mmol) of anhydrous nickel bromide and 200 g of N-methylpyrrolidone into a flask was stirred at a bath temperature of 70° C. After it was confirmed that anhydrous nickel bromide is dissolved, the bath temperature was lowered to 50° C. and 2.93 g (18.7 mmol) of 2,2′-bipyridyl was added thereto, whereby a nickel-containing solution was prepared.

In the atmosphere of argon, 3.35 g of the polymer represented by formula (B-1) above and 240 g of N-methylpyrrolidone were put into a flask and the temperature was adjusted to 50° C. A mixture obtained by adding 3.06 g (46.9 mmol) of zinc particles, 0.863 g of a mixed solution of 1 part by weight of methanesulfonic acid and 9 parts by weight of N-methylpyrrolidone, and 20.0 g (38.2 mmol) of di(2,2-dimethylpropyl) 4,4′-dichlorobiphenyl-2,2′-disulfonate synthesized by the method described in Example 1 of JP-2007-270118-A to the resultant solution was stirred at 50° C. for 30 minutes. The nickel-containing solution was poured into the resultant and the resultant was polymerized at 50° C. for 5 hours, whereby a black polymer solution was obtained.

The obtained polymer solution was put to 2800 g of 13 wt % hydrochloric acid and the resultant was stirred at the room temperature for 30 minutes. The deposited precipitates were collected by filtration, the resultant was added to 2800 g of 13 wt % hydrochloric acid, the resultant was stirred at the room temperature for 30 minutes, and then the resultant was filtrated. The collected solid was washed with ion-exchange water until the pH of the filtrate is higher than 4.600 g of ion-exchange water and 700 g of methanol were added to the obtained crude polymer and the resultant was heated and stirred at a bath temperature of 90° C. for 1 hour. By filtrating and drying the crude polymer, 20.5 g of the polymer having a sulfonic precursor group ((2,2-dimethylpropyl) sulfonate group) was obtained.

The sulfonic precursor group was converted into a sulfo group as follows.

A mixture obtained by putting 19.7 g of the polymer having a sulfonic precursor group obtained as described above, 44.2 g of ion-exchange water, 13.3 g (153 mmol) of anhydrous lithium bromide, and 295 g of N-methylpyrrolidone into a flask was heated and stirred at a bath temperature of 126° C. for 12 hours, whereby a polymer solution was obtained. The obtained polymer solution was added to 2751 g of 13 wt % hydrochloric acid and the resultant was stirred for 1 hour. The deposited crude polymer was collected by filtration, and the process of washing the collected crude polymer with 983 g of a mixed solution of 10 parts by weight of methanol and 10 parts by weight of 35% hydrochloric acid was repeatedly carried out three times. Thereafter, the crude polymer was washed with ion-exchange water until the pH of the filtrate is higher than 4. Subsequently, a washing process of adding a large amount of ion-exchange water was to the obtained polymer, raising the temperature to 90° C. or higher, maintaining the temperature for about 10 minutes, and filtrating the resultant was repeatedly carried out four times. By drying the resultant polymer, 15.1 g of Polymer Electrolyte 3 represented by formula (B-2) below was obtained.

GPC Molecular Weight: Mn=362000 and Mw=683000

IEC: 4.7 meq/g

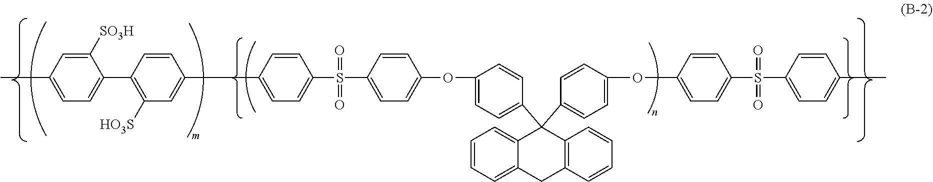

### [Preparation of Polymer Electrolyte Membranes 1 to 2]

Polymer Electrolyte 1 obtained in Synthesis Example 1 was dissolved in N,N-dimethyl sulfoxide to prepare a solution with a concentration of 10 wt %. The resultant solution was defined as Polymer Electrolyte Solution (A).

The obtained Polymer Electrolyte Solution (A) was continuously cast onto a polyethylene terephthalate (PET) film (E5000 grade, made by Toyobo Co., Ltd.) with a width of 300 mm as a support substrate using a slot die, and the resultant was continuously transported into a drying furnace using hot air and heater to remove the solvent. At this time, by changing the thickness of the polymer electrolyte solution to be cast, two types of polymer electrolyte membrane intermediates were obtained. The obtained polymer electrolyte membrane intermediates were immersed in a 2 N hydrochloric acid for 2 hours, and the resultants were washed with water for 2 hours, were dried with wind, and were peeled from the support substrates, whereby Polymer Electrolyte Membrane 1 and Polymer Electrolyte Membrane 2 were produced.

The thicknesses of Polymer Electrolyte Membrane 1 and Polymer Electrolyte Membrane 2 were 5.6 μm and 21.1 μm, respectively.

### [Preparation of Polymer Electrolyte Membranes 3 and 4]

Polymer Electrolyte 2 obtained in Synthesis Example 2 was dissolved in N-methylpyrrolidone to prepare a polymer electrolyte solution. Thereafter, the obtained polymer electrolyte solution was cast onto a PET film, the resultant is dried at a normal temperature and 80° C. for 2 hours to remove the solvent therefrom, and the resultant was subjected to treatment with hydrochloric acid and washing with ion-exchange water, whereby Polymer Electrolyte Membrane 3 with a thickness of about 20 μm and Polymer Electrolyte Membrane 4 with a thickness of about 10 μm were produced.

### [Preparation of Polymer Electrolyte Membrane 5]

Polymer Electrolyte 3 obtained in Synthesis Example 3 was dissolved in N-methylpyrrolidone to prepare a polymer electrolyte solution. Thereafter, the obtained polymer electrolyte solution was cast onto a PET film, the resultant is dried at a normal temperature and 80° C. for 2 hours to remove the solvent therefrom, and the resultant was subjected to treatment with hydrochloric acid and washing with ion-exchange water, whereby Polymer Electrolyte Membrane 5 with a thickness of about 20 μm was produced.

### Examples 1 to 4

The water vapor permeability coefficient, the oxygen permeability coefficient, the water vapor permeability, the oxygen permeability, the tension strength, and the electric power generation characteristic of Polymer Electrolyte Membrane 1, Polymer Electrolyte Membrane 3, Polymer Electrolyte Membrane 4, and Polymer Electrolyte Membrane 5 were evaluated. The evaluation results are shown in Table 1.

### Comparative Example 1

The water vapor permeability coefficient, the oxygen permeability coefficient, the water vapor permeability, the oxygen permeability, the tension strength, and the electric power generation characteristic of Polymer Electrolyte Membrane 2 were evaluated. The evaluation results are shown in Table 1.

### Comparative Example 2

The water vapor permeability coefficient, the oxygen permeability coefficient, and the electric power generation characteristic of NRE211CS (made by Du Pont de Nemours & Co.) which is a membrane formed of perfluorosulfonic acid polymer commercially available were evaluated. The thickness of NRE211CS was 26.5 μm. The evaluation results are shown in Table 2.

TABLE 2

| | Example | | | | Comparative Example | |
|---|---|---|---|---|---|---|
| | 1 | 2 | 3 | 4 | 1 | 2 |
| Polymer electrolyte membrane | 1 | 3 | 4 | 5 | 2 | NRE211CS |
| Water vapor permeability | 7.3 × 10⁻¹⁰ | 3.3 × 10⁻⁹ | 2.2 × 10⁻⁹ | 3.2 × 10⁻⁹ | 6.5 × 10⁻¹⁰ | 3.7 × 10⁻⁹ |
| coefficient (mol/sec/cm) | | | | | | |
| Water vapor permeability | 1.3 × 10⁻⁶ | 1.4 × 10⁻⁶ | 2.1 × 10⁻⁶ | 2.0 × 10⁻⁶ | 3.1 × 10⁻⁷ | 1.4 × 10⁻⁶ |
| (mol/sec/cm²) | | | | | | |
| Oxygen permeability coefficient | 3.5 × 10⁻¹⁰ | 9.3 × 10⁻¹¹ | 5.5 × 10⁻¹¹ | 6.3 × 10⁻¹¹ | 4.3 × 10⁻¹⁰ | 3.1 × 10⁻⁹ |
| (cc·cm/cm²·sec·cmH) | | | | | | |
| Oxygen permeability | 4.1 × 10⁴ | 2.9 × 10³ | 3.3 × 10³ | 2.1 × 10³ | 1.4 × 10⁴ | 7.8 × 10⁴ |
| (cc/m²·24 h·atm) | | | | | | |
| Breaking stress (MPa) | 32 | 26 | 41 | 21 | 32 | 8 |
| Temperature at which voltage is | 92 | 92 | 100 | 101 | 81 | 76 |
| less than 0.1 V (°C.) | | | | | | |

### INDUSTRIAL APPLICABILITY

According to the present invention, it is possible to provide a polymer electrolyte membrane having superior high-temperature operability and enhanced electric power generation performance. It is also possible to provide a membrane-electrode assembly (MEA) and a solid polymer fuel cell employing the polymer electrolyte membrane.

1. A polymer electrolyte membrane comprising a polymer electrolyte and having a first surface and a second surface,
wherein the water vapor permeability coefficient from the first surface of the polymer electrolyte membrane to the second surface which is measured in a state where the first surface is exposed to a humidified environment of a temperature of 85° C. and a relative humidity of 20% and the second surface is exposed to a non-humidified environment of a temperature of 85° C. and a relative humidity of 0% is equal to or higher than 7.0×10⁻¹⁰ mol/sec/cm, and the breaking stress at a temperature of 80° C. and a relative humidity of 90% is equal to or greater than 20 MPa.

2. A polymer electrolyte membrane comprising a polymer electrolyte and having a first surface and a second surface,
wherein the water vapor permeability coefficient from the first surface of the polymer electrolyte membrane to the second surface which is measured in a state where the first surface is exposed to a humidified environment of a temperature of 85° C. and a relative humidity of 20% and the second surface is exposed to a non-humidified environment of a temperature of 85° C. and a relative humidity of 0% is equal to or higher than 7.0×10⁻¹⁰ mol/sec/cm, and the oxygen permeability coefficient from the first surface to the second surface is equal to or less than 1.0×10⁻⁹ cc·cm/cm²·sec·cmHg.

3. The polymer electrolyte membrane according to claim 1, wherein the ion exchange capacity of the polymer electrolyte is equal to or greater than 3.0 meq/g.

4. The polymer electrolyte membrane according to claim 3, wherein the thickness of the polymer electrolyte membrane is in the range of not less than 10 μm and not more than 40 μm.

5. The polymer electrolyte membrane according to claim 1, wherein the thickness of the polymer electrolyte membrane is in the range of not less than 3 μm and not more than 12 μm.

6. The polymer electrolyte membrane according to claim 5, wherein the ion exchange capacity of the polymer electrolyte is in the range of not less than 2.0 meq/g and not more than 3.0 meq/g.

7. A polymer electrolyte membrane comprising a polymer electrolyte and having a first surface and a second surface,
wherein the water vapor permeability from the first surface of the polymer electrolyte membrane to the second surface which is measured in a state where the first surface is exposed to a humidified environment of a temperature of 85° C. and a relative humidity of 20% and the second surface is exposed to a non-humidified environment of a temperature of 85° C. and a relative humidity of 0% is equal to or higher than 1.0×10⁻⁶ mol/sec/cm², and the oxygen permeability from the first surface to the second surface is equal to or less than 5.0×10⁴ cc/m²·24 h·atm.

8. The polymer electrolyte membrane according to claim 1, wherein the polymer electrolyte is a hydrocarbon-based polymer electrolyte.

9. The polymer electrolyte membrane according to claim 1, wherein the polymer electrolyte is an aromatic polymer electrolyte.

10. The polymer electrolyte membrane according to claim 1, wherein the polymer electrolyte includes a segment having an ion-exchange group and a segment having substantially no ion-exchange groups and the segment having an ion-exchange group has a structure represented by formulas (1a), (2a), (3a), or (4a) below: 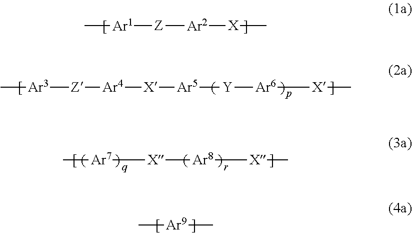
wherein Ar¹ to Ar⁹ each independently represents an aromatic group which has an aromatic ring in a main chain and which may have a side chain having an aromatic ring, at least one of the aromatic ring in the main chain and the aromatic ring in the side chain has an ion-exchange group directly bonded to the aromatic ring, Z and Z′ each independently represents either CO or SO₂, X, X′ and X″ each independently represents either O or S, Y represents a direct bond or a group represented by formula (10) below, p represents 0, 1 or 2, and q and r each independently represents 1, 2 or 3, 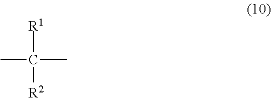
wherein R¹ and R² each represents a hydrogen atom, an alkyl group with a carbon number of 1 to 20 which may have a substituent group, an alkoxy group with a carbon number of 1 to 20 which may have a substituent group, an aryl group with a carbon number of 6 to 20 which may have a substituent group, an aryloxy group with a carbon number of 6 to 20 which may have a substituent group, or an acyl group with a carbon number of 2 to 20 which may have a substituent group, and R¹ and R² may be linked to form a ring.

11. The polymer electrolyte membrane according to claim 1, wherein Ar¹ to Ar⁹ each have at least one ion-exchange group in the aromatic group constituting the main chain.

12. The polymer electrolyte membrane according to claim 1, wherein the polymer electrolyte is a copolymer electrolyte which includes a segment having an ion-exchange group and a segment having substantially no ion-exchange groups and the copolymerization pattern of which is block copolymerization or graft copolymerization,
the polymer electrolyte membrane has a microphase-separated structure comprising a phase in which the density of the segment having an ion-exchange group is higher than the density of the segment having substantially no ion-exchange groups, and a phase in which the density of the segment having substantially no ion-exchange groups is higher than the density of the segment having an ion-exchange group.

13. A membrane-electrode assembly comprising the polymer electrolyte membrane according to claim 1.

14. A solid polymer fuel cell comprising the membrane-electrode assembly according to claim 13.
